(19) United States
(12) Patent Application Publication
(10) Pub. No.: US 2017/0064529 A1
(43) Pub. Date: Mar. 2, 2017

(54) SYSTEM FOR AUTOMATICALLY TRANSMITTING EMERGENCY SIGNAL USING SMART PHONE, AND METHOD THEREFOR

(71) Applicants: Se-yong LEE, Seoul (KR); Kyo-Sik HONG, Seongnam (KR); TW MOBILE CO.,LTD, Seocho-gu Seoul (KR)

(72) Inventors: Se-yong Lee, Seoul (KR); Kyo-sik Hong, Seongnam (KR)

(21) Appl. No.: 15/119,712

(22) PCT Filed: Feb. 12, 2015
(86) PCT No.: PCT/KR2015/001415

§ 371 Date: Aug. 17, 2016

(30) Foreign Application Priority Data
Feb. 17, 2014 (KR) 10-2014-0018108

(51) Int. Cl. H04W 4/22; H04W 4/02; G08B 25/01

(52) U.S. Cl. CPC H04W 4/22; G08B 25/016; H04W 4/02

(57) ABSTRACT

The present invention provides an urgent signal transmission system using a smart phone. A user previously registers a specific voice in a smart phone having a voice recognition function. If an input of the previously registered voice capable of determining that an urgent situation occurs is recognized, or if it is determined that the user is in an urgent situation by an application through shaking of the smart phone sensed by a moving sensor or any key operation, urgent signal generation location information and a help request signal are transmitted to a smart phone of an acquaintance who is located within a predetermined radius from a location of the smart phone as a reference point and is closest to the user or a smart phone of a third party who is a specific SNS member to which the user is subscribed and is located near the user.

### TECHNICAL FIELD

The present invention relates to an urgent signal transmission system using a smart phone and a method thereof, and more particularly, to an urgent signal transmission system using a smart phone capable of quickly receiving help by extracting a subject located within a predetermined radius on the basis of a location of a smart phone of a user as a reference point and transmitting urgent signal generation location information and a help request signal to a smart phone of a specific subject, for a group having higher priority among transmitting target groups that are previously classified into a plurality of groups if it is determined that the user is in an urgent situation by an application on the basis of a signal input of the user, and a method thereof.

### BACKGROUND ART

Recently, individuals have highly interested in the accumulation of wealth for private properties with the development of capitalism, and at this point in time, people have taken a necessity for a service for protecting a body of an individual and a family for granted.

Actually, various types of violent crimes, i.e. kidnapping, robbery, and injury cases are rapidly increased as a gap between the rich and the poor is enlarged and an unemployment rate is increased.

Therefore, when robbery and kidnapping cases occur, portable high voltage apparatuses that can directly overwhelm the opponent have been released in recent years. However, for the user using the portable high voltage apparatus to directly overwhelm the opponent, considerable courage and agility are required. Since the user mostly carries the high voltage apparatus in a handbag, etc., it is very difficult for him/her to take the high voltage apparatus out of the handbag under a situation that he/she is threatened with deadly weapons such as a knife.

Further, since the robbery, injury, and kidnapping cases mostly occur to the weak old men, children, and women, it is very difficult for the weak users to directly overwhelm the opponent.

In addition, a failure in overwhelming the opponent in the robbery, injury, and kidnapping cases arouses the emotion of the opponent, and therefore it is highly likely to cause an adverse effect.

Therefore, recently, a security phone having a GPS function embedded therein and automatically notifying remote servers such as a server of national police agency or a server of a security company a location and an urgent situation of a user using the security phone has been introduced. However, even in the case of the security phone, the user directly operates a mobile phone, and therefore, it is also difficult to transmit specific information by operating a hot key of the mobile phone under the situation that the user is threatened with deadly weapons such as a knife.

Further, even though the conventional security phone notifies the server of the national police agency or the server of the security company of the urgent situation to notify a phone of the national police agency or the security company of the urgent situation, when the user is distant from a service agent, the user is highly likely to have an accident before the service agent reaches the scene.

Meanwhile, when a user who is in a danger situation asks unspecified third parties for help, the situation in which the unspecified third parties may be another dangerous person may not be excluded.

### DISCLOSURE

### Technical Problem

In consideration of the above-mentioned circumstances, it is an object of the present invention to provide an urgent signal transmission system using a smart phone capable of quickly receiving help by extracting a subject located within a predetermined radius on the basis of a location of a smart phone of a user as a reference point and transmitting urgent signal generation location information and a help request signal to a smart phone of a specific subject, for a group having higher priority among transmitting target groups that are previously classified into a plurality of groups if it is determined that the user is in an urgent situation by an application on the basis of a signal input of the user, and a method thereof.

### Technical Solution

In order to accomplish the above objects, there is provided a system of automatically transmitting an urgent signal using a smart phone, including: an urgent signal transmitting smart phone 2 which has an urgent signal generation application 4 installed therein configured to transmit identification information on acquaintances to an urgent signal processing server 10 in an order of high priority when an urgent situation occurs, in a state in which acquaintances classified into a plurality of groups are stored by setting priority, receive location information on each acquaintance from the urgent signal processing server 10 to determine whether the acquaintances are within a predetermined radius, and transmit a previously registered urgent help request data 12 to an urgent signal receiving smart phone 3 of the corresponding acquaintance; the urgent signal processing server 10 configured to receive the location information from the urgent signal receiving smart phone 3 and update the received location information, and when receiving a specific telephone number from the urgent signal transmitting smart phone 2, transmit location information corresponding to the telephone number to the urgent signal transmitting smart phone 2; and the urgent signal receiving smart phone 3 configured to receive urgent help request data 12 including location information of a user from the urgent signal transmitting smart phone 2 and output the received urgent help request data 12.

Preferably, the urgent signal transmitting smart phone 2 transmits the urgent help request data 12 to the urgent signal receiving smart phone 3 of an unspecific third party located within the predetermined radius from a reference point in which the user is located without classifying the group.

Preferably, the urgent help request data 12 includes: text information 14 notifying a help request; picture information 16 of allowing a third party to recognize a user requesting help; and location information 18 for allowing the third party to recognize the location of the user requesting help.

Preferably, the urgent signal generation application 4 determines that the user is in the urgent situation, when the same voice data as a previously registered voice data is input, when a moving sensor installed in the smart phone receives an input signal over a predetermined frequency, when an application icon is operated on a screen, or when any external key is operated over the predetermined frequency.

Preferably, the group is selected and set by the user from a personal telephone directory group stored in the urgent signal transmitting smart phone 2, an option relevant person group among specific SNS subscribers, a specific SNS subscriber group, an option relevant person group among unspecific third parties within the predetermined radius, and an unspecific third party group within the predetermined radius.

Preferably, the urgent signal generation application 4 operates in conjunction with an SNS application 8 to automatically input urgent help request characters to an input window.

Preferably, the urgent signal processing server 10 transmits the urgent help request data 12 to the urgent signal receiving smart phone 3 within the predetermined radius by the request of the urgent signal transmitting smart phone 2.

Preferably, the urgent signal generation application 4 receives the location information by a predetermined time period in conjunction with a GPS module 22 installed in the smart phone.

Preferably, the urgent signal transmitting smart phone 2 includes: a communication module 38 configured to perform communication with an external device; a signal input unit 30 configured to receive a signal to operate an application for generating an urgent help request signal; a GPS module 40 configured to receive the location information of the user from a GPS satellite; a help request information setting unit 48 configured to set information in advance to perform automatic transmission when the urgent situation occurs; an information transmission unit 5 configured to transmit the help request information set in the help request information setting unit 48 with a specific telephone number; and a control unit 58 configured to receive a signal from the signal input unit 30 to determine whether the urgent situation occurs, and transmit the help request information previously registered to the user within the predetermined radius when the urgent situation occurs, along with current location information.

Preferably, the urgent signal transmitting smart phone 2 further includes: an urgent signal transmitting target setting unit 46 configured to set the urgent signal transmitting target, wherein the urgent signal transmitting target setting unit 46 sets priority for generating the help request with being classified by group.

Preferably, the urgent signal transmitting smart phone 2 further includes: a data storing unit 56 configured to store an urgent signal transmitting target by group.

Preferably, the urgent signal transmitting smart phone 2 further includes: a location calculation unit 44 configured to receive location information of a target which transmits an urgent help request signal to determine whether the user is within the predetermined radius; and a help request signal transmission target determination unit 50 configured to determine a final urgent help request signal transmitting target.

Preferably, the urgent signal transmitting smart phone 2 further includes: an automatic character input unit 52 configured to automatically input characters to an input window of an SNS application in conjunction with the SNS application.

Preferably, an option of the option relevant person is an option by occupation, sex, and age.

Preferably, the signal input unit 30 includes: a voice recognition module 32 configured to compare a previously registered voice with an input voice to determine whether the previously registered voice matches with the input voice; a moving sensor 34 configured to sense shaking of the smart phone over a predetermined frequency and a predetermined strength; and an application driving key 36 configured to be output on a screen of the smart phone with being clickable.

According to the present invention, there is also provided a method of automatically transmitting an urgent signal using a smart phone, including: a) receiving, by an urgent signal processing server 10, each location information from a plurality of urgent signal receiving smart phones 3, and registering the received location information; b) receiving, by an urgent signal generation application 4 installed in an urgent signal transmitting smart phone 2, a signal of a user to determine whether the signal is the urgent signal; c) transmitting, by the urgent signal generation application 4, urgent help request information including current location information to the urgent signal processing server 10, when the signal of the user is the urgent signal; and d) transmitting, by the urgent signal processing server 10, urgent help request information of a user to the urgent signal receiving smart phone 3 located within a predetermined radius.

Preferably, the method further includes: before the step a), receiving and setting, by the urgent signal generation application 4, predetermined radius information of the user.

Preferably, the steps c) and d) are replaced by: e) transmitting, by the urgent signal generation application 4, urgent help request information including current location information and identification information on each user belonging to a specific group to the urgent signal processing server 10; f) receiving, by the urgent signal generation application 4, location information of a user matching with each identification information on a group from the urgent signal processing server 10; g) extracting, by the urgent signal generation application 4, identification information present within the predetermined radius; and h) transmitting, by the urgent signal generation application 4, an urgent help request signal as the identification information present within the predetermined radius.

Preferably, the identification information is a telephone number or an SNS ID.

Preferably, the method further includes: before the step e), receiving and registering, by the urgent signal generation application 4, groups having a plurality of classified identification information; and receiving and registering, by the urgent signal generation application 4, priorities for each group.

Preferably, the step g) further includes: requesting, by the urgent signal generation application 4, location information of identification information on a second ranking group to the urgent signal processing server 10, when identification information on a specific group is not present within the predetermined radius.

Preferably, the steps c) and d) are replaced by: driving, by the urgent signal generation application 4, an SNS application; and transmitting, by the urgent signal generation application 4, an urgent help request signal to an input window of the SNS application.

Preferably, in the step g), calculating locations of each user belonging to the group based on a current location of the user as a reference point to determine whether the user is within the predetermined radius.

The method according to claim 16, where in the step f), the location information of the user matching with each of the identification information is not exposed to a screen.

### Advantageous Effects

The urgent signal transmission system using a smart phone and the method of the same may allow users such as children, old men, and handicapped persons having a weak body to generate the urgent signal and may allow third parties located around them to quickly move to the locations of the users on the basis of the location information and the personal information of the users output through the application to help them, thereby escape persons who are in the urgent situation from a danger with the help of several users, in particular, the present invention may classify the signal receiving subject into a plurality of groups and transmit the urgent help request signal from the group having higher priority, thereby positively receiving the help and guarantee privacy.

### DESCRIPTION OF DRAWINGS

FIG. 1 is a block diagram schematically illustrating a configuration of an urgent signal transmission system using a smart phone according to an embodiment of the present invention.

FIG. 2 is a diagram illustrating a state in which a help request transmitting target is set by the urgent signal transmission system using a smart phone according to the embodiment of the present invention.

FIG. 3 is a diagram illustration a state in which the transmitting target is extracted by the urgent signal transmission system using a smart phone according to the embodiment of the present invention.

FIG. 4 is a diagram illustrating urgent help request data transmitted through the urgent signal transmission system using a smart phone according to the embodiment of the present invention.

FIG. 5 is a diagram illustrating a state in which the transmitting target is extracted and the help request signal is transmitted by the urgent signal transmission system using a smart phone according to the embodiment of the present invention.

FIG. 6 is a block diagram illustrating a configuration of a user smart phone included in the urgent signal transmission system using a smart phone according to the embodiment of the present invention.

FIG. 7 is a flow chart illustrating a signal flow of the urgent signal transmission system using a smart phone according to the embodiment of the present invention.

### BEST MODE

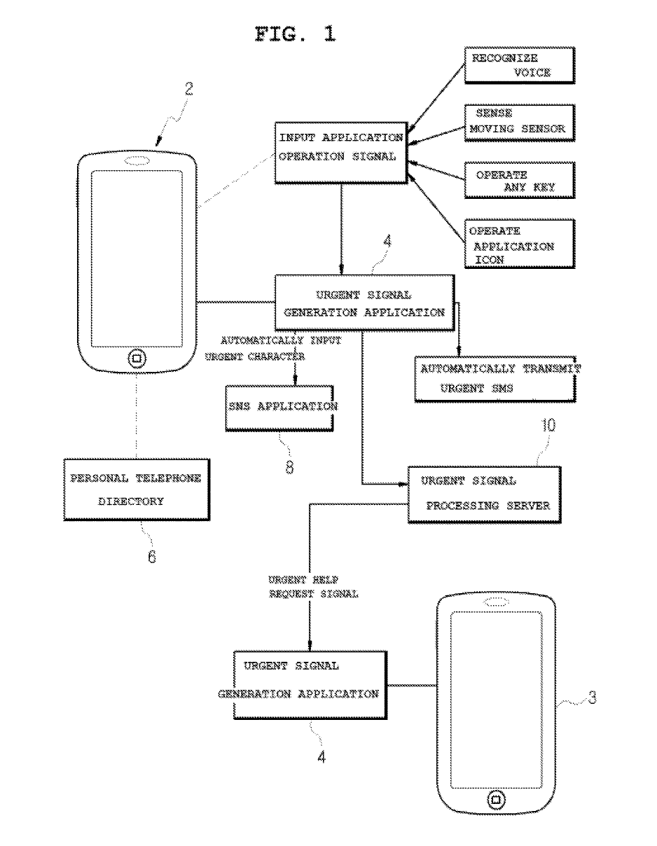

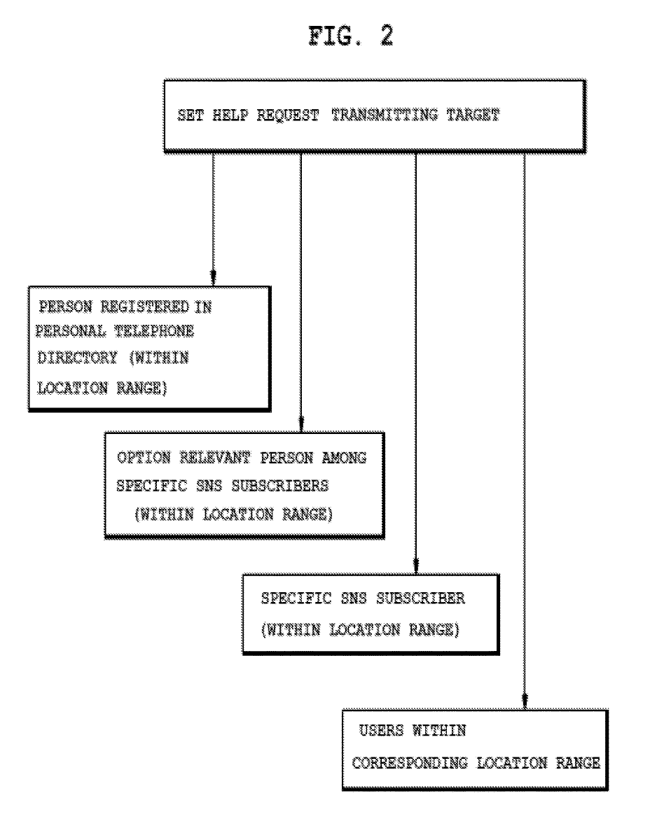

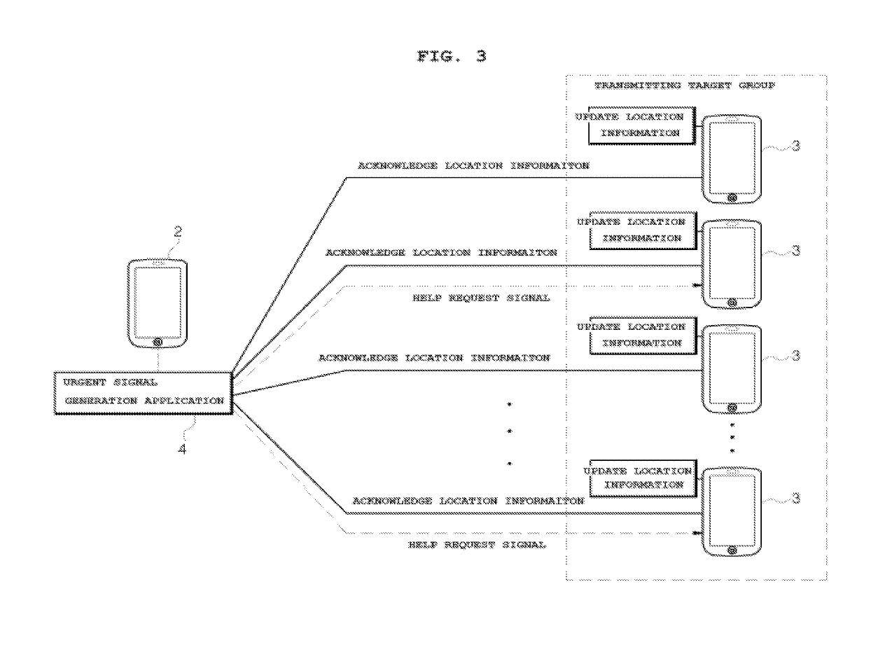

Hereinafter, the present invention will be described with reference to the accompanying drawings in detail. FIG. 1 is a block diagram schematically illustrating a configuration of an urgent signal transmission system using a smart phone according to an embodiment of the present invention, FIG. 2 is a diagram illustrating a state in which a help request transmitting target is set by the urgent signal transmission system using a smart phone according to the embodiment of the present invention, and FIG. 3 is a diagram illustration a state in which the transmitting target is extracted by the urgent signal transmission system using a smart phone according to the embodiment of the present invention.

Referring to the drawings, an urgent signal transmission system using a smart phone according to an embodiment of the present invention is a system capable of quickly receiving help by extracting a subject located within a predetermined radius on the basis of a location of a smart phone of a user as a reference point and transmitting urgent signal generation location information and a help request signal to a smart phone of a specific subject, for a group having higher priority among transmitting target groups that are previously classified into a plurality of groups if it is determined that the user is in an urgent situation by an application on the basis of a signal input of the user.

That is, the urgent signal transmission system using a smart phone according to the embodiment of the present invention may allow a user to previously register a specific voice in a smart phone of the user having a voice recognition function, and may recognize an input of a previously registered voice capable of determining as an urgent situation. Alternately, the user may input his/her urgent situation by an application through shaking of the smart phone sensed by a moving sensor or any key operation.

Further, the urgent signal transmission system using a smart phone according to the embodiment of the present invention transmits a help request signal from a user to third parties within a predetermined radius when the user is in an urgent situation. More preferably, the present invention may guarantee privacy by transmitting the help request signal only to subjects which correspond to a specific telephone number or identification information that is previously established by the user and are present within a predetermined radius.

Further, the urgent signal transmission system using a smart phone according to the embodiment of the present invention includes an application which classifies a plurality of groups that are a help request signal transmitting target by priority to determine whether a third party belonging to a first ranking group is within a predetermined radius from a location where the user is present and determine whether the third party belonging to a second ranking group is within the predetermined radius from the location where the user is present.

In more detail, when the user is in the urgent situation, the urgent signal transmission system using a smart phone according to the embodiment of the present invention is a system which transmits the urgent help request signal to persons around the user to request a help. Transmitting the urgent help request signal may be classified into several types according to a signal transmitting target and a communication means.

First, the user who is in the urgent situation may also transmit the urgent help request signal to acquaintances who are located around the user, transmit the urgent help request signal to unspecified third parties who are located around the user, and transmit the urgent help request signal to SNS acquaintances regardless of the location.

Further, the user who intends to deliver the urgent help request signal to the acquaintances who are located around the user as a target may transmit the help request signal to acquaintances recorded in a personal telephone directory personally stored in his/her smart phone or acquaintances belonging to an SNS group who are located around the user.

In this case, the user may limit the transmitting target on the basis of an occupation, an age, and a sex as an option for the acquaintances belonging to the SNS group who are located around the user.

More specifically, the urgent signal transmission system using a smart phone according to the embodiment of the present invention is a system which includes an urgent signal transmitting smart phone 2 for generating a help request signal to a third party located at a remote location when the user is in an urgent situation with carrying the smart phone, and an urgent signal receiving smart phone 3 for receiving the urgent help request signal from the urgent signal transmitting smart phone 2 to enable the third parties located near the user to help the user who is in the urgent situation using location information of the urgent signal receiving smart phone 3, when receiving the urgent help request signal from any one urgent signal transmitting smart phones 2 in a state in which a location of the urgent signal receiving smart phone 3 is updated by a predetermined time period.

In this case, the urgent signal transmitting smart phone 2 is a smart phone that has an urgent signal generation application 4 installed therein configured to transmit identification information on acquaintances to an urgent signal processing server 10 in an order of high priority when the urgent situation occurs, in a state in which acquaintances classified into a plurality of groups are stored by setting priority, receive the location information on each acquaintance from the urgent signal processing server 10 to determine whether the acquaintances are within the predetermined radius, and transmit a previously registered urgent help request data 12 to the urgent signal receiving smart phone 3 of the corresponding acquaintance.

The urgent signal generation application 4 performs communication with the urgent signal processing server 10 so as to receive location information on specific identification information (for example, a telephone number). The urgent signal generation application 4 may not expose the location information on the screen to transmit only the urgent help request signal to the urgent signal receiving smart phone 3 of the acquaintance with preventing invasion of privacy.

Further, the urgent signal processing server 10 receives the location information from the urgent signal receiving smart phone 3 and updates the received location information, and when receiving a specific telephone number from the urgent signal transmitting smart phone 2, transmits location information corresponding to the telephone number to the urgent signal transmitting smart phone 2.

Meanwhile, similar to the urgent signal transmitting smart phone 2, the urgent signal receiving smart phone 3 is a smart phone which has the urgent signal generation application 4 installed therein, but is a smart phone receiving the urgent signal, and therefore for convenience of description, is assigned with names and reference numbers different therefrom.

In this case, the urgent signal receiving smart phone 3 is a smart phone that receives urgent help request data 12 including the location information of the user from the urgent signal transmitting smart phone 2 and outputs the urgent help request data 12.

When transmitting the urgent help request signal, the urgent signal generation application 4 classifies recipients into a plurality of groups and registers them, and assigns priority to the plurality of groups. Therefore, the urgent signal generation application 4 operates in conjunction with a personal telephone directory 6 provided in the urgent signal transmitting smart phone 2.

In this case, the user may select and set the group from a personal telephone directory group stored in the urgent signal transmitting smart phone 2, an option relevant person group among specific SNS subscribers, a specific SNS subscriber group, an option relevant person group among the unspecific third parties within a predetermined radius, and an unspecific third party group within the predetermined radius.

Therefore, the urgent signal generation application 4 is configured to first transmit the urgent help request data to acquaintances belonging to a group having higher priority. The priority group includes acquaintances belonging to the group having higher priority have strong cohesion with the user, such that a person who may more positively help the user upon the help request.

Meanwhile, the acquaintances belonging to the group having higher priority may not be present around a user who is in a danger. Therefore, the urgent signal generation application 4 repeats a process of comparing the location information of the acquaintances belonging to the first ranking group to determine whether the acquaintances of the first ranking group present within a predetermined radius are present, and if it is determined that the acquaintances are not present within the predetermined radius, determine whether the acquaintances of the second ranking group are present within the predetermined radius, thereby performing the location comparison up to a lower priority group in which the acquaintances are present.

If the acquaintances are not present within the radius up to the lower group, the urgent signal generation application 4 may transmit the urgent help request data to the urgent signal receiving smart phone 3 of the unspecific third party located within the predetermined radius from a reference point at which the user is located without distinction of group.

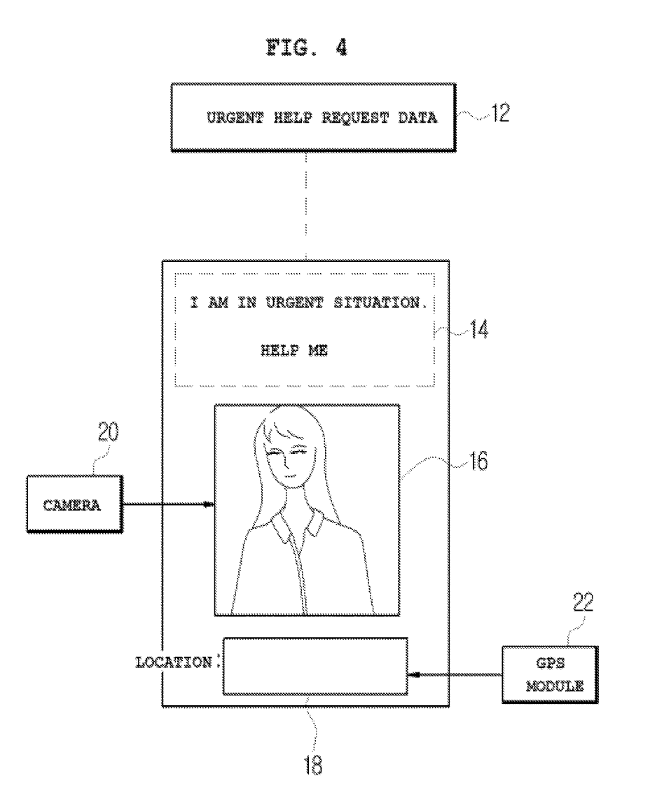

In this case, the urgent signal receiving smart phone 3 of the unspecific third party who may receive the help request signal is a smart phone which has the urgent signal generation application 4 installed therein. The urgent help request data will be described in detail with reference to FIG. 4 below.

Meanwhile, the urgent signal transmission system using a smart phone according to the embodiment of the present invention may allow the urgent signal generation application 4 installed in the urgent signal transmitting smart phone 2 to determine whether the user is in the urgent situation. The user should be able to generate the urgent help request signal in the state in which the third party around the user does not recognize the signal of the user.

That is, if the user who is a feeble-body person such as child or woman is in a robbery or kidnapping situation, the user may request help to an outside without a robber or a kidnapper being noticed.

In this case, the urgent signal generation application 4 may receive the urgent signal of the user in various manners, but four representative schemes will be described below.

The first scheme of generating the urgent signal is a scheme of determining whether the user is currently in the urgent situation on the basis of the voice recognition. That is, in the first scheme, the urgent signal generation application 4 compares a previously registered urgent signal generating voice data with a voice data input by the user in conjunction with a voice recognition module, and determines that the user is in the urgent situation if it is determined these data agree with each other.

For example, if the user previously registers “Don't kill me” as the urgent signal generating voice data in the urgent signal generation application 4, the urgent signal generation application 4 transmits the urgent help request data to the urgent signal receiving smart phone 3 if the voice data is input.

The second scheme is a scheme of allowing the urgent signal generation application 4 to determine that the user is in the urgent situation, when the smart phone shakes over a predetermined frequency sensed by a moving sensor installed in urgent signal transmitting smart phone 2.

The third scheme is a scheme of allowing the urgent signal generation application 4 to determine that the user is in the urgent situation, if any key installed on the outside of the urgent signal transmitting smart phone 2 is operated.

The fourth scheme is a scheme of directly operating an icon displayed on the screen of the urgent signal transmitting smart phone 2 to input the urgent situation to the urgent signal generation application 4.

Meanwhile, the urgent signal generation application 4 operates in conjunction with an SNS application 8 to automatically input urgent help request characters to an input window.

That is, the urgent signal transmission system using a smart phone according to the embodiment of the present invention may allow the urgent signal generation application 4 installed in the urgent signal transmitting smart phone 2 to activate the SNS application 8 regardless of the location and automatically input the urgent help request data.

For example, the urgent signal generation application 4 may drive the SNS application 8 such as a Facebook, and automatically input the urgent help request data to a character input window of the Facebook. Then, followers of the user Facebook may acknowledge the urgent help request data and help the user.

Further, even when the user asks an SNS subscriber located near the user for help in consideration of the location information, in order to acknowledge the subscriber located near the user among the followers of his/her Facebook, the urgent signal generation application 4 installed in the urgent signal receiving smart phone 3 updates his/her location by a time period, thus, it is possible to transmit a location of a subscriber having a specific ID to the urgent signal transmitting smart phone 2 in conjunction with the SNS application 8.

By doing so, the user who uses the urgent signal transmitting smart phone 2 may determine whether a subscriber having specific SNS identification information is currently present in an area around the user, and may notify a plurality of followers located around the user that the user is in the urgent situation.

Meanwhile, the urgent signal transmission system using a smart phone according to the embodiment of the present invention may allow the urgent signal processing server 10 to receive the urgent help request signal from the urgent signal transmitting smart phone 2 and transmit the urgent help request data to the urgent signal receiving smart phone 3, or may allow the urgent signal transmitting smart phone 2 to directly transmit the urgent help request signal to the urgent signal receiving smart phone 3.

Since the urgent signal processing server 10 grasps the location of the urgent signal transmitting smart phone 2 and the location of the urgent signal receiving smart phone 3, it is possible to determine whether the urgent signal receiving smart phones 3 are present within the predetermined radius from the urgent signal transmitting smart phone 2 by mutually calculating respective location coordinates.

Similarly, the urgent signal transmitting smart phone 2 requests and receives the location coordinates of the urgent signal receiving smart phone 3 having a specific telephone number to the urgent signal processing server 10, thus, it is possible to determine whether the urgent signal receiving smart phones 3 are present within the predetermined radius from the urgent signal transmitting smart phone 2 by mutually calculating the respective location coordinates.

Therefore, the urgent signal generation applications 4 installed in the urgent signal transmitting smart phone 2 and the urgent signal receiving smart phone 3 receives the location information in conjunction with GPS modules 22 which are installed in the smart phones by a predetermined time period.

Meanwhile, the user may set a separate option to set a receiving target group of the urgent signal. In particular, when a target receiving the urgent signal is an unspecific third party inevitably located nearest the user, a receiving limitation option may be set by occupation, sex, and age.

For example, when members of a group having priority are not located near the user, the target inevitably receiving the urgent signal is the unspecific third party located nearest the user. In this case, it is preferable to transmit the urgent help request signal to only a subject satisfying option matters by setting an option in advance.

That is, as the occupation, there may be a teacher, a police, a janitor, a shopkeeper whose residence is fixed, etc., as the sex, male or female may be selected by a user, and as the target age, an age range determined to help the user while being safe for the user may be set.

FIG. 4 is a diagram illustrating urgent help request data transmitted through the urgent signal transmission system using a smart phone according to the embodiment of the present invention.

Referring to FIG. 4, urgent help request data 12 transmitted through the urgent signal transmission system using a smart phone according to the embodiment of the present invention may optionally include text information 14 notifying a help request, picture information 16 for allowing a third party to recognize a user requesting help, and location information 18 for allowing the third party to recognize the location of the user requesting help.

As a result, it is preferable that the user periodically captures his/her face photograph using a camera 20 installed in the smart phone to update the picture information 16 formed in the urgent help request data 12 in advance, thus to allow the third party to easily recognize the picture information 16.

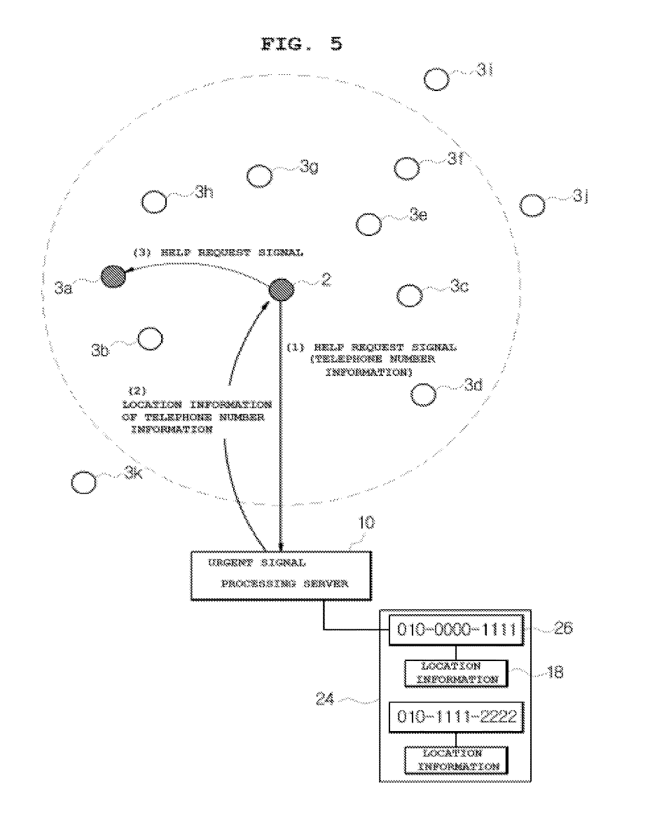

FIG. 5 is a diagram illustrating a state in which the transmitting target is extracted and the help request signal is transmitted by the urgent signal transmission system using a smart phone according to the embodiment of the present invention.

Referring to FIG. 5, as described above, the urgent signal transmission system using a smart phone according to the embodiment of the present invention may allow the urgent signal processing server 10 to receive the urgent help request signal from the urgent signal transmitting smart phone 2 and transmit the urgent help request data to the urgent signal receiving smart phone 3, or may allow the urgent signal transmitting smart phone 2 to directly transmit the urgent help request signal to the urgent signal receiving smart phone 3.

Directly transmitting the urgent help request signal to the urgent signal receiving smart phone 3 by the urgent signal transmitting smart phone 2 will be described with reference to FIG. 5.

First, the urgent signal processing server 10 receives the location information from urgent signal receiving smart phones 3a to 3k and the urgent signal transmitting smart phone 2 every predetermined time period and updates the received location information.

In this state, if receiving plurality of identification information, for example, location information request signals for a plurality of telephone numbers from one of the urgent signal transmitting smart phones 2, the urgent signal processing server 10 transmits location information on a telephone number to the urgent signal transmitting smart phone 2.

Then, the urgent signal transmitting smart phone 2 calculates the urgent signal receiving smart phones 3a to 3k having any telephone number are located within a predetermined radius to extract the urgent signal receiving smart phones 3a to 3h that are a transmitting target.

Further, the urgent signal transmitting smart phone 2 transmits the urgent help request data to the urgent signal receiving smart phones 3a to 3h.

Therefore, the urgent signal processing server 10 includes a data storing unit 24 that stores the location information 18 matching with each of the plurality pieces of identification information 26.

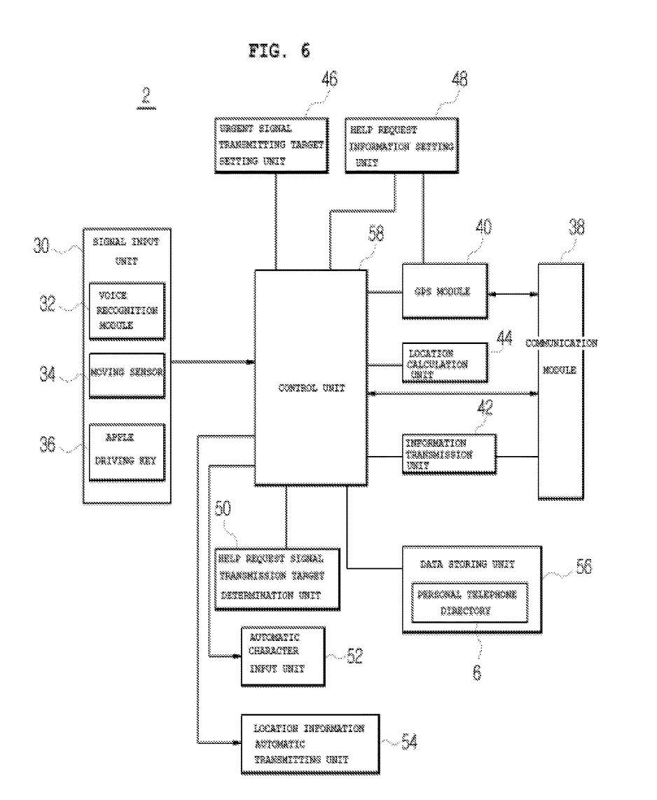

FIG. 6 is a block diagram illustrating a configuration of a user smart phone included in the urgent signal transmission system using a smart phone according to the embodiment of the present invention.

Referring to FIG. 6, the urgent signal transmitting smart phone 2 includes: a communication module 38 for performing communication with an external device; a signal input unit 30 receiving a signal to operate an application for generating an urgent help request signal; a GPS module 40 for receiving location information of a user from a GPS satellite; a help request information setting unit 48 for setting information in advance to perform automatic transmission upon an urgent situation; an information transmitting unit 5 for transmitting help request information set in the help request information setting unit 48 with a specific telephone number; a control unit 58 for receiving a signal from the signal input unit 30 to determine the urgent situation and perform a control to transmit the help request information previously registered to the user within a predetermined radius when the urgent situation occurs, along with current location information.

In this case, the signal input unit 30 includes a voice recognition module 32 for comparing a previously registered voice with an input voice to determine whether the previously registered voice matches with the input voice, a moving sensor 34 for sensing shaking of a smart phone over a predetermined frequency and a predetermined strength, and an application driving key 36 to be output on a screen of the smart phone with being clickable.

Herein, the urgent signal transmitting smart phone 2 further includes an urgent signal transmitting target setting unit 46 for setting an urgent signal transmitting target. The urgent signal transmitting target setting unit 46 sets priority for generating the help request signal with being classified by group.

In addition, the urgent signal transmitting smart phone 2 further includes a data storing unit 56 for storing an urgent signal transmitting target by group.

In addition, the urgent signal transmitting smart phone 2 further includes a location calculation unit 44 for receiving location information of a target which transmits the urgent help request signal and determining whether the user is within the predetermined radius, and a help request signal transmission target determination unit 50 for determining a final urgent help request signal transmitting target.

Preferably, the urgent signal transmitting smart phone 2 further includes an automatic character input unit 52 operating in conjunction with an SNS application to automatically input characters to an input window of the SNS application.

The function and operation of the urgent signal transmission system using a smart phone according to the embodiment of the present invention having the foregoing configuration will be described in detail with reference to the accompanying drawings.

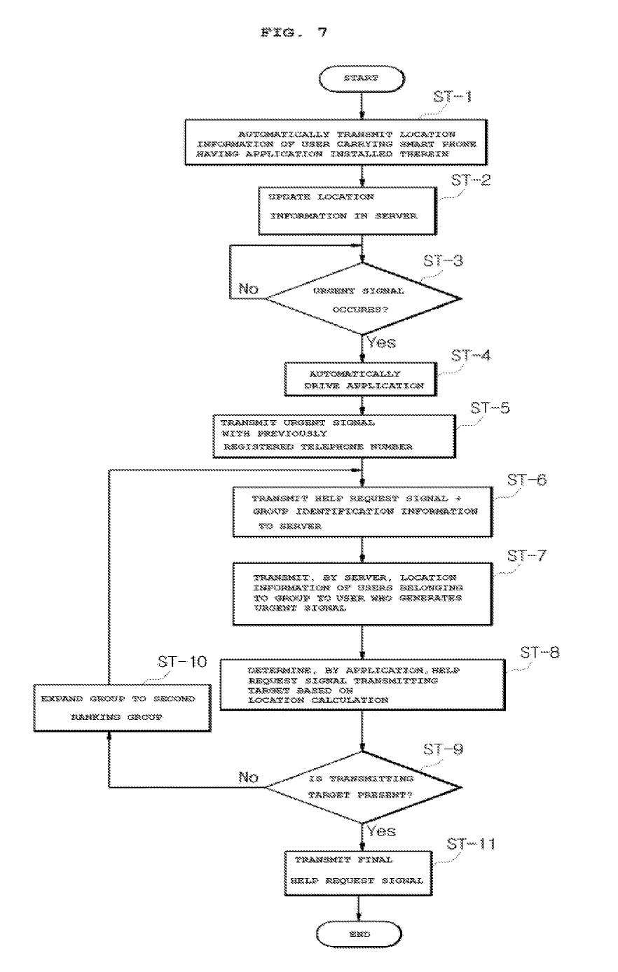

FIG. 7 is a flow chart illustrating a signal flow of the urgent signal transmission system using a smart phone according to the embodiment of the present invention.

First, the urgent signal transmission system using a smart phone according to the embodiment of the present invention allows the urgent signal processing server 10 to receive each location information from the plurality of urgent signal receiving smart phones 3 and register the received location information.

The present invention may allow third parties located around a user who is in an urgent situation to quickly help the user, and therefore the urgent signal generation application 4 installed in each smart phone updates the location information by a predetermined time period in the urgent signal processing server 10.

In this state, the urgent signal generation application 4 installed in the urgent signal transmitting smart phone 2 receives a signal of a user to determine whether the signal is the urgent signal.

The urgent signal is generated by the signal input of the user, and if it is determined that the input signal of the user is the urgent signal, the urgent signal generation application 4 transmits the urgent help request signal including the current location information to the urgent signal processing server 10.

Next, the urgent signal processing server 10 transmits the urgent help request information of the user to the urgent signal receiving smart phone 3 located within the predetermined radius.

In this case, the urgent signal generation application 4 receives the predetermined radius information from the user in advance and sets the radius.

The urgent signal processing server 10 updates the locations of the users having the smart phone with the urgent signal generation application 4 in real time, and therefore if receiving the urgent help request signal from any one of the users, may quickly transmit the urgent help request signal to at least one assistant located nearby.

It is preferable that the assistant helping the user who is in the urgent situation is a direct acquaintance of the user or an indirect acquaintance of the user since the assistant may more positively help the user.

Meanwhile, as described above, the urgent signal transmission system using a smart phone according to the embodiment of the present invention may allow the urgent signal processing server 10 to transmit the urgent help request signal of the specific user to the assistant nearby but the urgent signal generation application 4 installed in the urgent signal transmitting smart phone 2 of the user may directly search for the assistant nearby to transmit the signal.

That is, since the subject of the signal transmission is a subject of the location calculation, the subject of the signal transmission may be changed depending on whether the location calculation is processed by the server or the urgent signal transmitting smart phone 2.

Hereinafter, reviewing the case in which the urgent signal transmitting smart phone 2 is the subject of the signal transmission, first, the urgent signal generation application 4 transmits the urgent help request information including the current location information and the identification information on each user belonging to the specific group to the urgent signal processing server 10.

Then, the urgent signal generation application 4 receives the location information of the user matching with each identification information on the group from the urgent signal processing server 10, and the identification information present within the predetermined radius is extracted by the urgent signal generation application 4. In this case, the identification information is identification information including a telephone number or an SNS ID.

Further, the urgent signal generation application 4 transmits the urgent help request signal to the identification information present within the predetermined radius.

More preferably, the urgent signal generation application 4 registers the priority of the signal transmission by group in advance, and transmits a signal according to the priorities for each group.

For example, the urgent signal generation application 4 receives and registers groups having a plurality of classified identification information. Then, the urgent signal generation application 4 receives and registers the priorities for each group.

Therefore, when identification information on a specific group is not present within the predetermined radius, the urgent signal generation application 4 requests the location information of the identification information on the second ranking group to the urgent signal processing server 10.

For example, the system of the present invention first grasps the locations of the acquaintances classified as the groups of the first ranking acquaintances to determine whether the acquaintances are present nearby, and if it is determined that the first ranking acquaintances are not presented nearby, determines whether the second ranking acquaintances are present.

That is, the urgent signal generation application 4 sets the current location of the user as the reference point to calculate the locations of each user belonging to the group and determine whether the user is within the predetermined radius.

Preferably, in this case, the location information of the user matching with each identification information is designed not to be exposed to the screen, and the user need not grasp the location information of the acquaintance.

Meanwhile, the urgent signal transmission system using the smart phone according to the embodiment of the present invention allows the urgent signal generation application 4 to automatically drive the SNS application, such that the urgent signal generation application 4 may also input the urgent help request information to the input window of the SNS application.

In this case, the urgent help request data is input to the input window of the SNS application such as Twitter or Facebook. Therefore, the location information of the user and the urgent help request signal are just input regardless of the location information of the acquaintances to help the followers, etc.

Meanwhile, the urgent signal transmission system and the method of the same in accordance with the exemplary embodiment of the present invention are not limited to only the above described embodiments, but may be variously changed without departing from the technical subjects thereof.

1-24. (canceled)

25. A system of automatically transmitting an urgent signal using a smart phone, comprising:
an urgent signal transmitting smart phone which has an urgent signal generation application installed therein configured to transmit identification information on acquaintances to an urgent signal processing server in an order of high priority when an urgent situation occurs, in a state in which acquaintances classified into a plurality of groups are stored by setting priority, receive location information on each acquaintance from the urgent signal processing server to determine whether the acquaintances are within a predetermined radius, and transmit a previously registered urgent help request data to an urgent signal receiving smart phone of the corresponding acquaintance;
the urgent signal processing server configured to receive the location information from the urgent signal receiving smart phone and update the received location information, and when receiving a specific telephone number from the urgent signal transmitting smart phone, transmit location information corresponding to the telephone number to the urgent signal transmitting smart phone; and
the urgent signal receiving smart phone configured to receive urgent help request data including location information of a user from the urgent signal transmitting smart phone and output the received urgent help request data.

26. The system according to claim 25, wherein the urgent signal transmitting smart phone transmits the urgent help request data to the urgent signal receiving smart phone of an unspecific third party located within the predetermined radius from a reference point in which the user is located without classifying the group.

27. The system according to claim 25, wherein the urgent help request data includes: text information notifying a help request; picture information of allowing a third party to recognize a user requesting help; and location information for allowing the third party to recognize the location of the user requesting help.

28. The system according to claim 25, wherein the urgent signal generation application determines that the user is in the urgent situation, when the same voice data as a previously registered voice data is input, when a moving sensor installed in the smart phone receives an input signal over a predetermined frequency, when an application icon is operated on a screen, or when any external key is operated over the predetermined frequency.

29. The system according to claim 25, wherein the group is selected and set by the user from a personal telephone directory group stored in the urgent signal transmitting smart phone, an option relevant person group among specific SNS subscribers, a specific SNS subscriber group, an option relevant person group among unspecific third parties within the predetermined radius, and an unspecific third party group within the predetermined radius.

30. The system according to claim 25, wherein the urgent signal generation application operates in conjunction with an SNS application to automatically input urgent help request characters to an input window.

31. The system according to claim 25, wherein the urgent signal processing server transmits the urgent help request data to the urgent signal receiving smart phone within the predetermined radius by the request of the urgent signal transmitting smart phone.

32. The system according to claim 25, wherein the urgent signal generation application receives the location information by a predetermined time period in conjunction with a GPS module installed in the smart phone.

33. The system according to claim 25, wherein the urgent signal transmitting smart phone comprises:
a communication module configured to perform communication with an external device;
a signal input unit configured to receive a signal to operate an application for generating an urgent help request signal;
a GPS module configured to receive the location information of the user from a GPS satellite;
a help request information setting unit configured to set information in advance to perform automatic transmission when the urgent situation occurs;
an information transmission unit configured to transmit the help request information set in the help request information setting unit with a specific telephone number; and
a control unit configured to receive a signal from the signal input unit to determine whether the urgent situation occurs, and transmit the help request information previously registered to the user within the predetermined radius when the urgent situation occurs, along with current location information.

34. The system according to claim 25, wherein the urgent signal transmitting smart phone further comprises: an urgent signal transmitting target setting unit configured to set the urgent signal transmitting target, wherein the urgent signal transmitting target setting unit 46 sets priority for generating the help request with being classified by group.

35. The system according to claim 25, wherein the urgent signal transmitting smart phone further comprises: a data storing unit configured to store an urgent signal transmitting target by group.

36. The system according to claim 25, wherein the urgent signal transmitting smart phone further comprises: a location calculation unit configured to receive location information of a target which transmits an urgent help request signal to determine whether the user is within the predetermined radius; and a help request signal transmission target determination unit configured to determine a final urgent help request signal transmitting target.

37. The system according to claim 25, wherein the urgent signal transmitting smart phone further comprises: an automatic character input unit configured to automatically input characters to an input window of an SNS application in conjunction with the SNS application.

38. The system according to claim 29, wherein an option of the option relevant person is an option by occupation, sex, and age.

39. The system according to claim 33, wherein the signal input unit comprises:
a voice recognition module configured to compare a previously registered voice with an input voice to determine whether the previously registered voice matches with the input voice;
a moving sensor configured to sense shaking of the smart phone over a predetermined frequency and a predetermined strength; and
an application driving key configured to be output on a screen of the smart phone with being clickable.

40. A method of automatically transmitting an urgent signal using a smart phone, comprising:
a) receiving, by an urgent signal processing server, each location information from a plurality of urgent signal receiving smart phones, and registering the received location information;
b) receiving, by an urgent signal generation application installed in an urgent signal transmitting smart phone, a signal of a user to determine whether the signal is the urgent signal;
c) transmitting, by the urgent signal generation application, urgent help request information including current location information to the urgent signal processing server, when the signal of the user is the urgent signal; and
d) transmitting, by the urgent signal processing server, urgent help request information of a user to the urgent signal receiving smart phone located within a predetermined radius.

41. The method according to claim 40, further comprising: before the step a), receiving and setting, by the urgent signal generation application, predetermined radius information of the user.

42. The method according to claim 40, wherein the steps c) and d) are replaced by:
e) transmitting, by the urgent signal generation application, urgent help request information including current location information and identification information on each user belonging to a specific group to the urgent signal processing server;
f) receiving, by the urgent signal generation application, location information of a user matching with each identification information on a group from the urgent signal processing server;
g) extracting, by the urgent signal generation application, identification information present within the predetermined radius; and
h) transmitting, by the urgent signal generation application, an urgent help request signal as the identification information present within the predetermined radius.

43. The method according to claim 42, wherein the identification information is a telephone number or an SNS ID.

44. The method according to claim 42, further comprising: before the step e), receiving and registering, by the urgent signal generation application, groups having a plurality of classified identification information; and receiving and registering, by the urgent signal generation application, priorities for each group.

45. The method according to claim 42, wherein the step g) further comprises: requesting, by the urgent signal generation application, location information of identification information on a second ranking group to the urgent signal processing server, when identification information on a specific group is not present within the predetermined radius.

46. The method according to claim 40, wherein the steps c) and d) are replaced by:
driving, by the urgent signal generation application, an SNS application; and
transmitting, by the urgent signal generation application, an urgent help request signal to an input window of the SNS application.

47. The method according to claim 42, wherein the step g) includes calculating locations of each user belonging to the group based on a current location of the user as a reference point to determine whether the user is within the predetermined radius.

48. The method according to claim 42, where in the step f), the location information of the user matching with each of the identification information is not exposed to a screen.
